(19) United States
(12) Patent Application Publication
(10) Pub. No.: US 2026/0087967 A1
(43) Pub. Date: Mar. 26, 2026

(54) DISPLAY DEVICE, DISPLAY CONTROL CIRCUIT AND IMAGE PROCESSING METHOD

(71) Applicant: Novatek Microelectronics Corp., Hsinchu (TW)

(72) Inventors: Tsu Cheng Li, Taichung City (TW); Yen-Tao Liao, Hsinchu City (TW); Hui-Feng Lin, Taichung City (TW)

(73) Assignee: Novatek Microelectronics Corp., Hsinchu (TW)

(21) Appl. No.: 19/333,365

(22) Filed: Sep. 19, 2025

Related U.S. Application Data
(60) Provisional application No. 63/696,869, filed on Sep. 20, 2024.

(51) Int. Cl. G09G 3/20; G09G 3/3208

(52) U.S. Cl. CPC G09G 3/2092; G09G 3/3208; G09G 2320/0257; G09G 2320/06; G09G 2320/103; G09G 2330/023; G09G 2354/00; G09G 2360/16

(57) ABSTRACT

Provided are a display device, a display control circuit, and an image processing method. The display device includes an OLED display panel and a display control circuit. The display control circuit adjusts data of a surrounding area of an input frame to generate an output frame. The OLED display panel displays the output frame which includes a main area and the surrounding area having a less luminance than the main area has. The main area is the area where the human eye is focused. The main area is set to normal luminance to maintain visual effects. The luminance of the surrounding area is lowered to save energy.

### CROSS-REFERENCE TO RELATED APPLICATION

This application claims the priority benefit of U.S. provisional application Ser. No. 63/696,869, filed on Sep. 20, 2024. The entirety of the above-mentioned patent application is hereby incorporated by reference herein and made a part of this specification.

### BACKGROUND

### Technical Field

The disclosure relates to an electronic device, and particularly relates to a display device, a display control circuit, and an image processing method.

### Related Art

Organic Light-Emitting Diode (OLED) display panels have been widely applied in various electronic devices. Generally, dimming the OLED display panel may save energy, but the visual effects are affected. How to balance energy saving and visual effects is one of the many technical issues in the display field.

### SUMMARY

The disclosure provides a display device, a display control circuit, and an image processing method to save energy.

In an embodiment of the disclosure, the display device includes an Organic Light-Emitting Diode (OLED) display panel and a display control circuit. The OLED display panel is configured to display a first output frame, in which the first output frame includes a main area and a surrounding area having a less luminance than the main area has. The display control circuit is configured to adjust data of the surrounding area of a first input frame to generate the first output frame.

In an embodiment of the disclosure, the display control circuit includes a luminance distribution determination circuit and an image adjustment circuit. The luminance distribution determination circuit is configured to determine luminance distribution for data of a surrounding area of a first input frame, in which the first input frame includes a main area and a surrounding area. The image adjustment circuit is coupled to the luminance distribution determination circuit. The image adjustment circuit is configured to adjust data of the surrounding area of the first input frame according to the luminance distribution to generate a first output frame, such that a surrounding area of the first output frame has a less luminance than a main area of the first output frame has.

In an embodiment of the disclosure, the display device includes an OLED display panel and a display control circuit. The OLED display panel is driven to display a first output frame in a normal mode and display a second output frame in a power saving mode. The OLED display panel has less power consumption in the power saving mode than in the normal mode. A surrounding area, which is an area other than a main area, of the second output frame has a less luminance than the surrounding area of the first output frame has. The display control circuit is coupled to the OLED display panel and configured to generate the first output frame and the second output frame, which results in a first luminance difference between the luminance of the main area of the second output frame and the luminance of the main area of the first output frame and a second luminance difference between the luminance of the surrounding area of the second output frame and the luminance of the surrounding area of the first output frame, wherein the second luminance difference is greater than the first luminance difference.

In an embodiment of the disclosure, the image processing method includes the following. Luminance distribution for data of a surrounding area of a first input frame is determined by a luminance distribution determination circuit of the display control circuit, in which the first input frame includes a main area and the surrounding area. Also, the data of the surrounding area of the first input frame is adjusted according to the luminance distribution by an image adjustment circuit of the display control circuit to generate a first output frame, such that a surrounding area of the first output frame has a less luminance than a main area of the first output frame has.

Based on the above, the display control circuit of various embodiments of the disclosure adjusts the data of the surrounding area of the input frame to generate the first output frame. For example, the display control circuit lowers the luminance of the surrounding area of the output frame, and maintains the luminance of the main area of the output frame as normal luminance. The main area is the area where the human eye is focused. Since the luminance of the main area is normal luminance, the visual effects can be maintained. The luminance of the surrounding area (the area where the human eye is not focused) is lowered to save energy.

To make the foregoing features and advantages of the disclosure more comprehensible, embodiments are described in detail below with reference to the accompanying drawings.

### BRIEF DESCRIPTION OF THE DRAWINGS

FIG. 1 is a circuit block diagram of a display device according to an embodiment of the disclosure.

FIG. 2 is a circuit block diagram of a display control circuit according to an embodiment of the disclosure.

FIG. 3 is a circuit block diagram of the display control circuit according to another embodiment of the disclosure.

FIG. 4 is a circuit block diagram of the display control circuit according to yet another embodiment of the disclosure.

FIG. 5 is a flow diagram of an image processing method of the display control circuit according to an embodiment of the disclosure.

FIG. 6 is an exemplary diagram of output frames generated by the display control circuit according to an embodiment of the disclosure.

### DESCRIPTION OF THE EMBODIMENTS

The term “couple (or connect)” used throughout the specification (including the claims) may refer to any direct or indirect connection means. For example, if a first device is described as being coupled (or connected) to a second device, it should be interpreted that the first device may be directly connected to the second device, or the first device may be indirectly connected to the second device through other devices or some connection means. The terms such as “first”, “second” mentioned throughout the specification (including the claims) are used to name elements or to distinguish different embodiments or ranges, and are not used to limit the maximum or minimum number of elements, nor to limit the order of elements. In addition, wherever possible, the same reference numerals for elements/components/steps in the drawings and embodiments represent the same or similar parts. Elements/components/steps with the same reference numerals or using the same terms in different embodiments may refer to related descriptions of each other.

Edge dimming function is one of the many power-saving functions of Organic Light-Emitting Diode (OLED) display. The edge dimming function divides the display screen into two major areas, center and periphery. When the edge dimming function is enabled, when the display screen is not updated for a period of time, the center area of the screen maintains the original luminance, while the area other than the center area is given different degrees of luminance reduction to achieve energy saving. However, in practical applications, the important image area on the screen (called the main area, which is a gaze area the human eye is focused, such as an active application window in the foreground) may not be within the center area of the display screen. If the area maintaining luminance is fixed at the center of the display screen, then such edge dimming function may cause the important image area or gaze area of the image to have reduced luminance, thereby affecting visual effects.

The power-saving function of OLED screen is that after the screen displays a static image (that is, the image data is not updated) for a period of time, the luminance of the entire screen is automatically reduced to save power, while having the effect of preventing OLED burn-in phenomenon. When the screen power-saving function is enabled and the screen remains static for a period of time, the screen luminance is reduced (the screen enters power-saving mode), but if the user still needs to view the screen at this time, a decrease in visual effects is significantly sensed. On the other hand, the system typically exits the screen power-saving mode due to any screen changes (such as moving the cursor, typing input). When the user is operating in a certain area of the screen, the entire display screen cannot enter the power-saving mode.

In summary, how to save energy while maintaining the visual effects of the important image area (he main area where the human eye is focused) is one of the many technical issues in the display field. The following embodiments provide a new edge dimming function, which allows OLED display to save energy and prevent the burn-in phenomenon while also adequately maintaining good visual effects. The display control circuit described in the following embodiments may be implemented in a timing controller chip of the display device, or implemented in an integrated display driver chip with a timing controller circuit. Taking the timing controller as an illustrative example, specific embodiments are as follows.

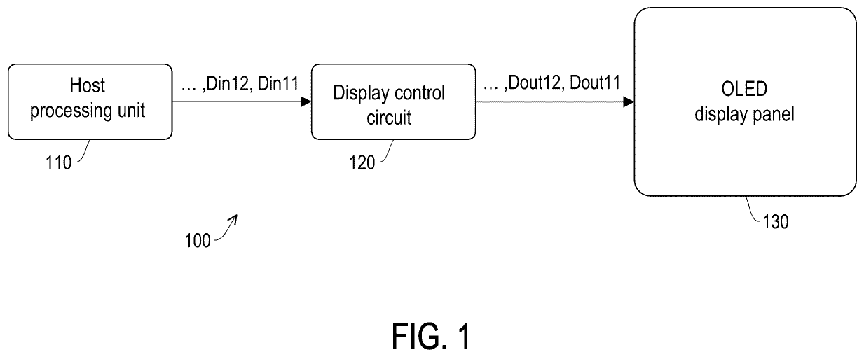

FIG. 1 is a circuit block diagram of a display device 100 according to an embodiment of the disclosure. The display device 100 includes a host processing unit 110, a display control circuit 120, and an OLED display panel 130. Based on actual design and application, the host processing unit 110 may include a Central Processing Unit (CPU), a Graphics Processing Unit (GPU), a scaler IC, and/or other processing circuits. The display control circuit 120 is coupled to the host processing unit 110 to receive an input frame Din11. According to different designs, in some embodiments, the display control circuit 120 may be implemented as hardware circuit. In other embodiments, the display control circuit 120 may be implemented as a combination of hardware, firmware, and software (that is, programs). In embodiments of the disclosure, if the display control circuit 120 is not integrated with a display driving circuit, a display driving circuit (not shown in FIG. 1) may be disposed between the display control circuit 120 and the OLED display panel 130. The display driving circuit is coupled to the display control circuit 120 and the OLED display panel 130 and is configured to convert image frames output from the display control circuit 120 into data voltages, to drive pixels of the OLED display panel 130.

In terms of hardware form, the display control circuit 120 may be implemented as logic circuits on an integrated circuit. For example, the related functions of the display control circuit 120 may be implemented in various logic blocks, modules, and circuits in one or more hardware controllers, microcontrollers, hardware processors, microprocessors, Application-specific Integrated Circuits (ASIC), Digital Signal Processors (DSP), Field Programmable Gate Arrays (FPGA), Central Processing Units (CPU), and/or other processing units. The related functions of the display control circuit 120 may be implemented as hardware circuits, such as various logic blocks, modules, and circuits in integrated circuits, using hardware description languages (such as Verilog HDL or VHDL) or other suitable programming languages.

In terms of software form and/or firmware form, the related functions of the display control circuit 120 may be implemented as programming codes. For example, the display control circuit 120 may be implemented using general programming languages (such as C, C++, or assembly language) or other suitable programming languages. The programming codes may be recorded/stored in a “non-transitory machine-readable storage medium”. In some embodiments, the non-transitory machine-readable storage medium may include semiconductor memory and/or storage devices. Electronic devices (such as computers, CPUs, hardware controllers, microcontrollers, hardware processors, or microprocessors) may read and execute the programming codes from the non-transitory machine-readable storage medium, thereby implementing the related functions of the display control circuit 120.

In embodiments of the disclosure, the area other than the main area (gaze area) is named a surrounding area. The display control circuit 120 adjusts data of the surrounding area of the main area of an input frame Din11 to generate an output frame Dout11. The main area is the gaze area where the human eye is focused, and the main area may be not fixed at the center of the output frame Dout11. This embodiment does not limit the manner to determine the main area. For example, the main area may be determined by the host processing unit 110, and the display control circuit 120 is configured to receive position information of the main area of the input frame Din11 from the host processing unit 110.

As another example, the display control circuit 120 is configured to determine the position information of the main area of the input frame Din11. The display control circuit 120 detects the size and position of the main area of the input frame Din11. For example (but not limited to), the display control circuit 120 detects the size and position of the active application window in the input frame Din11 as the size and position of the main area. The main area is not necessarily in the center area of the input frame Din11, and the display control circuit 120 may detect the main area located at any position. For example, an active browser window may be disposed in the upper-left of the input frame Din11.

As another example, the display control circuit 120 may determine the position information of the main area of the input frame Din11 by detecting pixel luminance. The display control circuit 120 determines the position information of the main area by performing block-based moving average on the input frame (such as the input frame Din11) and taking an area corresponding to a maximum moving average value as the main area. First, the display control circuit 120 calculates the average pixel level (APL) of each block in the input image frame (such as the input frame Din11) according to a predetermined size, such as 64*32 pixels as one block. Next, the display control circuit 120 calculates the moving average value of each block again using the moving average calculation method, forming an array of moving average values corresponding to one input frame. The display control circuit 120 may find the maximum value from the moving average values, and then the display control circuit 120 uses the block(s) (may be one or more) with the maximum moving average value as the main area. Alternatively, the display control circuit 120 uses all blocks with moving average values greater than a threshold as the main area.

As another example, the display control circuit 120 may determine the position information of the main area of the input frame Din11 by detecting object edges in the input frame. The display control circuit 120 determines the position information of the main area by performing block-based edge enhancement on the input frame (such as the input frame Din11). First, the display control circuit 120 calculates the average pixel data of each block according to the predetermined size of blocks in the input image frame (such as the input frame Din11). Next, the display control circuit 120 calculates the moving average value of each block again using the moving average calculation method, forming an array of moving average values corresponding to one input frame. The display control circuit 120 uses an image filter to process the moving average values to recognize edge characteristics in the input frame that may be the main area. According to the moving average values after edge enhancement processing, the display control circuit 120 determines the position of the main area. For example, the display control circuit 120 uses a closed area formed by blocks with moving average values greater than a threshold after edge enhancement processing as the main area.

The foregoing two main area detection methods may be used in combination. For example, the display control circuit 120 calculates the average pixel data of each block according to the predetermined size of blocks in the input image frame (such as the input frame Din11). Next, the display control circuit 120 calculates the moving average value of each block again using the moving average calculation method, forming moving average values corresponding to one input frame. The display control circuit 120 first uses the block with the maximum moving average value as the center position of the main area. The display control circuit 120 uses an image filter to process the moving average values to recognize edge characteristics in the input frame that may be the main area. According to the center position of the main area and the data array after edge enhancement processing, the display control circuit 120 determines a range of the main area.

As a further example, the display control circuit 120 may use a machine learning (ML) algorithm to determine the position information of the main area of the input frame Din11. First, the display control circuit 120 trains a machine learning model with an image database. The display control circuit 120 inputs the input frame to the trained machine learning model to determine the main area.

In the following embodiments of the disclosure, a power saving mode is a mode in which the OLED display panel has less power consumption than in a normal mode.

No matter the display control circuit 120 receives the input frame Din11 in a normal mode or in a power saving mode, the display control circuit 120 adjusts the data of the surrounding area of the input frame Din11 to generate the output frame Dout11, such that the surrounding area of the output frame Dout11 has a less luminance than the main area of the output frame Dout11 has. In other words, the display control circuit 120 adjusts the data of the surrounding area of the input frame Din11, to generate the output frame Dout11 including the surrounding area which has a less luminance than the main area of the output frame Dout11 has. This embodiment does not limit the manner the display control circuit 120 adjusts the data of the surrounding area. For example, the display control circuit 120 may adjust the data of the surrounding area of the input frame Din11 to generate the output frame Dout11 by applying a luminance weight matrix to the input frame Din11. The luminance weight matrix consists of a plurality of luminance weights corresponding to each image unit (which can be block-based). Similarly, the display control circuit 120 may adjust the data of the surrounding area of the input frame Din12 to generate the output frame Dout12. The OLED display panel 130 is coupled to the display control circuit 120 to receive the output frames, such as Dout11 and Dout12. The OLED display panel 130 displays the output frames Dout11 and Dout12 in sequence. Based on the data adjustment of the surrounding area by the display control circuit 120, the output frames Dout11 and Dout12 displayed by the OLED display panel 130 include a main area and a surrounding area having a less luminance than the main area has. That is, the display control circuit 120 controls the luminance of the surrounding area of the output frames Dout11 and Dout12 to be lower than the luminance of the surrounding area of the input frames Din1l and Din12 and maintains the luminance of the main area of the output frames Dout11 and Dout12 as normal luminance which may be same as the luminance of the main area of the input frames Din11 and Din12. Since the luminance of the main area (the area where the human eye is focused) is a normal luminance, the visual effects can be maintained. The luminance of the surrounding area (the area where the human eye is not focused) is lowered to save energy.

Based on actual design and application, in some embodiments, the display control circuit 120 is configured to detect a difference between the input frame Din11 and the input frame Din12 next to the input frame Din11. According to the difference, the display control circuit 120 adjusts a luminance weight matrix to generate an adjusted luminance weight matrix. In response to the difference between the input frames Din11 and Din12 being less than a threshold (this threshold may be determined according to actual design and application), the surrounding area of the output frame Dout12 may be given a less luminance than the surrounding area of the output frame Dout11 is given. That is, when the display control circuit 120 detects the surrounding area of an input frame has not changed (or has changed very little), the luminance of the surrounding area of the input frame may be reduced more. On the other hand, in response to the difference between the input frames Din11 and Din12 not being less than the threshold, the surrounding area of the output frame Dout12 may be given the same luminance as (or a smaller luminance decreasing than) the surrounding area of the output frame Dout11 is given. For the main area (gaze area) of the current input frame, the display control circuit 120 may not change the luminance of the main area to achieve optimal visual effect, thereby realizing better screen power saving and burn-in prevention effects. In the embodiments, different luminance weights/weight matrix assigned to the main area and the surrounding area may help achieve the effect that the luminance of the surrounding area of the input frame can be reduced more than the luminance of the main area of the input frame are reduced, when the display control circuit 120 detects data of the surrounding area of the input frame has not changed (or has changed very little).

In some embodiments, the display control circuit 120 may determine the reduction magnitude of the luminance weights or the luminance weight matrix based on an “image change weight,” and the “image change weight” may be a time-dependent parameter. The “image change weight” may be related to the number of input frames for which data remains unchanged. For example (but not limited to), if the number of input frames for which data remains unchanged reaches 120 frames, then the “image change weight” is 0.5; if the number of input frames for which data remains unchanged reaches 600 frames, then the “image change weight” is 0.2; if the number of input frames for which data remains unchanged is 0 (that is, data is continuously updated), then the “image change weight” is 1. The display control circuit 120 may apply the image change weight to the luminance weight matrix to generate an adjusted luminance weight matrix.

The data of the surrounding area of the input frame Din12 is adjusted to generate the output frame Dout12 (the output frame Dout12 is displayed by the OLED display panel 130 after the output frame Dout11) by applying the adjusted luminance weight matrix to the input frame Din12. When the display control circuit 120 detects that the image data of the surrounding area other than the main area has not changed, the display control circuit 120 gradually reduces the luminance weight of the surrounding area at different times (the luminance of the surrounding area of the image gradually dims), but the luminance of the main area remains unchanged.

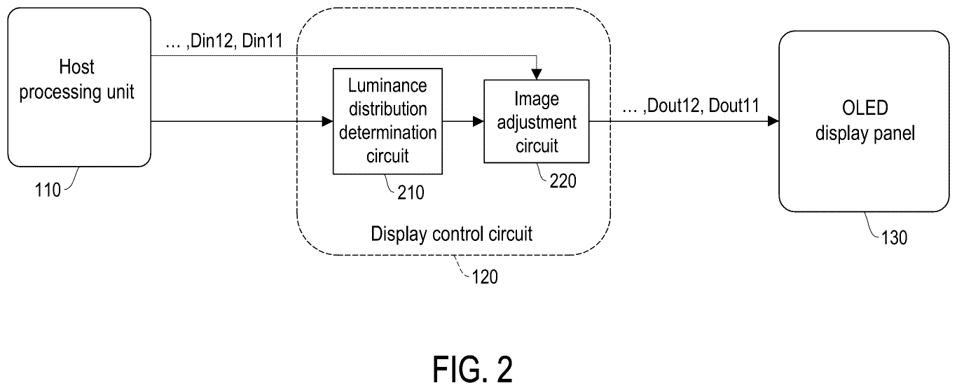

FIG. 2 is a circuit block diagram of a display control circuit 120 according to an embodiment of the disclosure. The display control circuit 120 shown in FIG. 2 may serve as one of many implementation examples of the display control circuit 120 shown in FIG. 1. The host processing unit 110, the input frame Din11, the input frame Din12, the display control circuit 120, the output frame Dout11, the output frame Dout12, and the OLED display panel 130 shown in FIG. 2 may refer to related descriptions of FIG. 1 and be extrapolated accordingly.

In the embodiment shown in FIG. 2, the main area may be determined by the host processing unit 110, and the display control circuit 120 is configured to receive position information of the main area of the input frame (for example, the input frame Din11) from the host processing unit 110. The display control circuit 120 shown in FIG. 2 includes a luminance distribution determination circuit 210 and an image adjustment circuit 220. The luminance distribution determination circuit 210 is configured to determine the luminance distribution for the data of the surrounding area of the input frame (for example, the input frame Din11). For example (but not limited to), the luminance distribution determined by the luminance distribution determination circuit 210 may include a luminance weight matrix. The luminance distribution determination circuit 210 (program code or digital circuit for calculating luminance weight) gives different luminance weights to the main area and surrounding area of the input image (for example, the input frame Din11) respectively. The main area is not limited to the center area of the image, and the main area may be at any position in the image. In this embodiment, the luminance weights of the main area and the surrounding area are not dichotomous, but gradually transition from the maximum luminance weight value corresponding to the main area to the minimum luminance weight value corresponding to the surrounding area. The overall luminance weight distribution may be represented as a luminance weight matrix, in which each element represents the luminance weight value applied to the corresponding image block (the size of the block may be the same as the block size used when detecting the main area, but the disclosure is not limited thereto). The luminance weight value is in a range of 0 to 1.

The image adjustment circuit 220 is coupled to the luminance distribution determination circuit 210. The image adjustment circuit 220 (program code or digital circuit for adjusting image data) adjusts the data of the surrounding area of the input frame (for example, the input frame Din11) according to the luminance distribution determined by the luminance distribution determination circuit 210 to generate an output frame (for example, the output frame Dout11), such that the surrounding area of the output frame has a less luminance than the main area of the output frame has. For example, after the image adjustment circuit 220 generates a luminance weight distribution (weight matrix) based on the main area, the image adjustment circuit 220 adjusts the data of the surrounding area of the input frame to generate an output frame (for example, the output frame Dout11) by applying the weight matrix to the input frame (for example, the input frame Din11), and the output frame is an output frame with edge dimming effect.

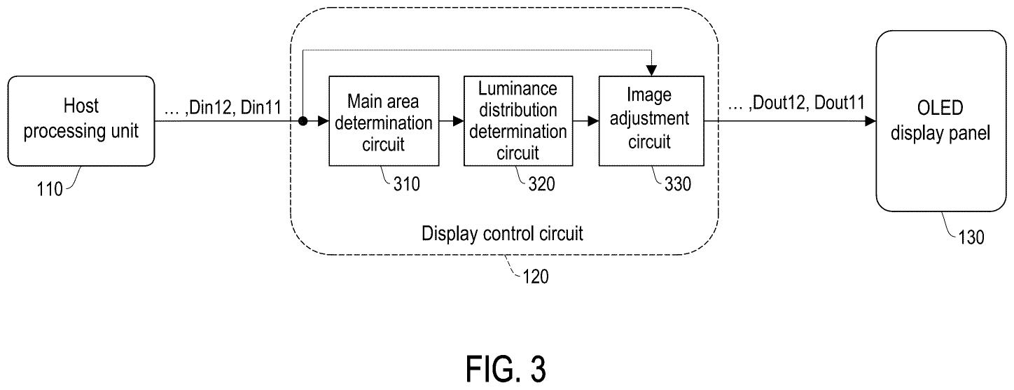

FIG. 3 is a circuit block diagram of the display control circuit 120 according to another embodiment of the disclosure. The display control circuit 120 shown in FIG. 3 may serve as one of many implementation examples of the display control circuit 120 shown in FIG. 1. The host processing unit 110, the input frame Din11, the input frame Din12, the display control circuit 120, the output frame Dout11, the output frame Dout12, and the OLED display panel 130 shown in FIG. 3 may refer to related descriptions of FIG. 1 and be extrapolated accordingly.

In the embodiment shown in FIG. 3, the position information of the main area may be determined by the display control circuit 120. The display control circuit 120 shown in FIG. 3 includes a main area determination circuit 310, a luminance distribution determination circuit 320, and an image adjustment circuit 330. The main area determination circuit 310 (program code or digital circuit for implementing main area detection algorithm) is configured to determine the position information of the main area of the input frame (for example, the input frame Din11). The main area determination circuit 310 is configured to detect the range size and position of the main area of the input image (for example, the input frame Din11). For example, in some embodiments, the main area determination circuit 310 determines the position information of the main area by performing block-based edge enhancement on the input frame. In other embodiments, the main area determination circuit 310 determines the position information of the main area by performing block-based moving average on the input frame and taking the area corresponding to the maximum moving average as the main area. The details of how the main area determination circuit 310 determines the position information of the main area may refer to the previous examples of how the display control circuit 120 determines the position information of the main area, so details will not be repeated here. Since the main area is not necessarily in the center area of the screen, using the main area determination circuit 310 may detect the main area located at any position.

The luminance distribution determination circuit 320 is coupled to the main area determination circuit 310 to receive the position information of the main area. The image adjustment circuit 330 is coupled to the luminance distribution determination circuit 320 to receive the luminance distribution (for example, the luminance weight matrix). The luminance distribution determination circuit 320 and the image adjustment circuit 330 shown in FIG. 3 may refer to related descriptions of the luminance distribution determination circuit 210 and the image adjustment circuit 220 shown in FIG. 2 and be extrapolated accordingly, so details will not be repeated here. The so-called edge dimming function refers to the image adjustment circuit 330 applying the luminance distribution (for example, the luminance weight matrix) generated by the luminance distribution determination circuit 320 to the input frame. With/without determining the luminance distribution based on the dynamic main area, there is a significant difference in the edge dimming effect. Generally, users would focus on the main area (for example, application window, such as browser window). With the main area detection function enabled, the display control circuit 120 may achieve better user experience by maintaining the visual effects while saving energy for the display device.

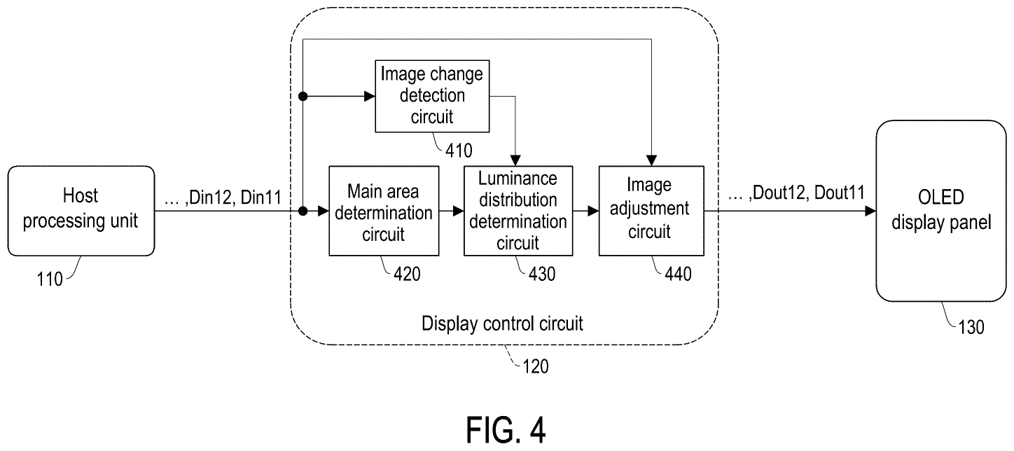

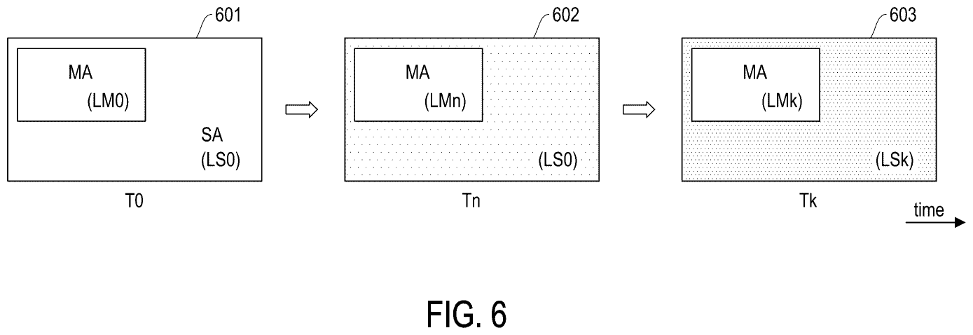

FIG. 4 is a circuit block diagram of the display control circuit 120 according to yet another embodiment of the disclosure. The display control circuit 120 shown in FIG. 4 may serve as one of many implementation examples of the display control circuit 120 shown in FIG. 1. The host processing unit 110, the input frame Din11, the input frame Din12, the display control circuit 120, the output frame Dout11, the output frame Dout12, and the OLED display panel 130 shown in FIG. 4 may refer to related descriptions of FIG. 1 and be extrapolated accordingly. Output frames generated by the display control circuit 120 of FIG. 4 can also be explained by FIG. 6.

In the embodiment shown in FIG. 4, the display control circuit 120 includes an image change detection circuit 410, a main area determination circuit 420, a luminance distribution determination circuit 430, and an image adjustment circuit 440. The image change detection circuit 410 may be program code or digital circuit for detecting whether there is any change between previous/current image data. The image change detection circuit 410 detects the difference (by block-based) between the input frame Din11 and the input frame Din12 next to the input frame Din11. The luminance distribution determination circuit 430 is coupled to the image change detection circuit 410 to receive the difference and is coupled to the main area determination circuit 420 to obtain the position information of the main area and the position information of the surrounding area. The luminance distribution determination circuit 430 adjusts the weight matrix according to the difference provided by the image change detection circuit 410 to generate an adjusted weight matrix. The image adjustment circuit 440 adjusts the data of the surrounding area of the input frame Din12 to generate the output frame Dout12 that is displayed after the output frame Dout11 by applying the adjusted weight matrix to the input frame Din12. For example, the surrounding area of the output frame Dout12 (e.g., output frame at Tn in FIG. 6) has a less luminance (LSn in FIG. 6) than the surrounding area of the output frame Dout11 has (i.e., the luminance LS0 in FIG. 6) in response to the difference between the surrounding area of the input frame Din11 and the surrounding area of the input frame Din12 being less than a threshold. On the other side, in response to the difference between the main area of the input frame Din11 and the main area of the input frame Din12 not being less than the threshold (i.e., changed large enough), the main area of the output frame Dout12 has the same luminance as the main area of the output frame Dout11 has (i.e., the luminance LMn=LM0 in FIG. 6).

The image change detection circuit 410 detects the input frame has not changed (or has changed very little) based on previous/current input frames and the detection may be block-based. When detecting the image blocks has not changed (or has changed very little), the image change detection circuit 410 controls the luminance distribution determination circuit 430 to increase the reduction magnitude of the luminance weight for the image blocks where have not changed enough, causing the luminance to be reduced more. On the other hand, the timing controller may control the luminance distribution determination circuit 430 to not change the luminance weight of image blocks which have changed to achieve optimal visual effect, as well as better screen power saving and burn-in prevention effects. The “image change weight” generated by the image change detection circuit 410 for the luminance distribution determination circuit 430 may determine the reduction magnitude of the luminance weight. The “image change weight” is a time-dependent parameter and may be related to the number of frames for which data remains unchanged. For example, if the number of frames for which data remains unchanged reaches 120 frames, then the “image change weight” is 0.5; if the number of frames for which data remains unchanged reaches 600 frames, then the “image change weight” is 0.2; if the number of frames for which data remains unchanged is 0 (that is, data is continuously updated), then the “image change weight” is 1. The luminance distribution determination circuit 430 may apply the image change weight to the luminance weight matrix to generate an adjusted luminance weight matrix. When the image change detection circuit 410 detects that the image data of the surrounding area other than the main area of the screen has not changed, the image change detection circuit 410 controls the luminance distribution determination circuit 430 to gradually reduce the luminance weight of the surrounding area at different times (the luminance of the surrounding area of the image gradually dims), but the luminance of the main area remains unchanged.

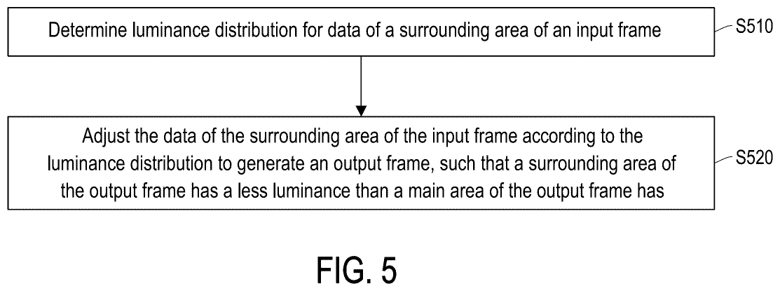

FIG. 5 is a flow diagram of an image processing method of the display control circuit according to an embodiment of the disclosure. In Step S510, the luminance distribution determination circuit determines luminance distribution for data of a surrounding area of a first input frame, in which the first input frame includes a main area and a surrounding area. In Step S520, the image adjustment circuit adjusts the data of the surrounding area of the first input frame according to the luminance distribution to generate a first output frame, such that the surrounding area of the first output frame has a less luminance than the main area of the first output frame has.

FIG. 6 is an exemplary diagram of output frames displayed by the image processing method of the display control circuit according to an embodiment of the disclosure. In FIG. 6, the main area of the output frames is denoted by MA and the surrounding area of the output frames is denoted by SA. In a time point TO, the OLED display panel displays under the normal mode, and the luminance of the main area of the output frame is LM0, the luminance of the surrounding area of the output frame is LS0, and LS0 may be less than LM0. In a time point Tn (after TO), the luminance of the main area of the output frame is LMn which equals LM0 and the luminance of the surrounding area of the output frame is LSn which is less than LS0, and that is the OLED display panel operates under the power saving mode. In a time point Tk (after Tn), the luminance of the main area of the output frame is LMk which still equals LM0 and the luminance of the surrounding area of the output frame is LSk which is less than LSn, and that is the OLED display panel operates under the power saving mode.

In another embodiment of the disclosure, in a case that the image change detection circuit 410 detects the main area of the input frame has changed but changed slightly and also detects the surrounding area of the input frame has not changed, the image change detection circuit 410 controls the luminance distribution determination circuit 430 to reduce the luminance for the main area and generate a greater reduction magnitude of the luminance weights for the surrounding area than the reduction magnitude of the luminance weight for the main area, which is LMn<LM0 and |LSn−LS0|>|LMn−LM0|.

It is noted that in the embodiments of the disclosure, the luminance weights corresponding to the boundary region between the main area and the surrounding area of the output frames are distributed in a gradient way. Take FIG. 6 as an example, in fact the luminance weights corresponding to the boundary pixels between the main area and the surrounding area is not from 1 (for main area) suddenly dropped to 0.5 (for surrounding area), but from 1 (for main area) gradually to 0.5 (for surrounding area), such as 1, 0.95, 0.90, 0.85, . . . , to 0.5.

In an embodiment, the image processing method further includes the following. The main area determination circuit determines position information of the main area of the first input frame.

In an embodiment, the image processing method further includes the following. The image adjustment circuit adjusts the data of the surrounding area of the first input frame to generate the first output frame by applying a weight matrix to the first input frame.

In an embodiment, the image processing method further includes the following. The position information of the main area of the first input frame is received from the host processing unit.

In an embodiment, the image processing method further includes the following. The image change detection circuit detects a difference between the first input frame and a second input frame next to the first input frame. The luminance distribution determination circuit adjusts the weight matrix according to the difference to generate an adjusted weight matrix. Also, the image adjustment circuit adjusts the data of the surrounding area of the second input frame to generate a second output frame by applying the adjusted weight matrix to the second input frame.

In an embodiment, the surrounding area of the second output frame has a less luminance than the surrounding area of the first output frame has in response to the difference between the first input frame and the second input frame being less than a threshold.

In an embodiment, the surrounding area of the second output frame has the same luminance as the surrounding area of the first output frame in response to the difference between the first input frame and the second input frame not being less than a threshold.

In an embodiment, the image processing method further includes the following. The main area determination circuit determines the position information of the main area by performing block-based edge enhancement on the first input frame.

In an embodiment, the image processing method further includes the following. The main area determination circuit determines the position information of the main area by performing block-based moving average on the first input frame and taking the area corresponding to the maximum moving average as the main area.

In summary, the display control circuit 120 adjusts the data of the surrounding area of the input frame to generate the first output frame. For example, the display control circuit 120 lowers the luminance of the surrounding area of the output frame, and maintains the luminance of the main area of the output frame as normal luminance. The main area is the area where the human eye is focused. Since the luminance of the main area is normal luminance, the visual effects can be maintained. Moreover, the display control circuit 120 lowers the luminance of the surrounding area (the area where the human eye is not focused) to save energy.

Although the disclosure has been disclosed by the foregoing embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A display device, comprising:
an OLED display panel configured to display a first output frame, wherein the first output frame comprises a main area and a surrounding area having a less luminance than the main area has; and
a display control circuit configured to adjust data of a surrounding area of a first input frame to generate the first output frame.

2. The display device according to claim 1, wherein the display control circuit adjusts the data of the surrounding area of the first input frame to generate the first output frame by applying a weight matrix to the first input frame.

3. The display device according to claim 1, further comprising:
a host processing unit coupled to the display control circuit, wherein the display control circuit is configured to receive position information of a main area of the first input frame from the host processing unit.

4. The display device according to claim 1, wherein the display control circuit is configured to determine position information of a main area of the first input frame.

5. The display device according to claim 1, wherein the display control circuit is configured to:
detect a difference between the first input frame and a second input frame next to the first input frame;
adjust a weight matrix according to the difference, to generate an adjusted weight matrix; and
adjust data of a surrounding area of the second input frame to generate a second output frame by applying the adjusted weight matrix to the second input frame, wherein the second output frame is displayed by the OLED display panel after the first output frame.

6. The display device according to claim 5, wherein a surrounding area of the second output frame has a less luminance than the surrounding area of the first output frame has in response to the difference between the first input frame and the second input frame being less than a threshold.

7. The display device according to claim 5, wherein a surrounding area of the second output frame has same luminance as the surrounding area of the first output frame in response to the difference between the first input frame and the second input frame not being less than a threshold.

8. The display device according to claim 4, wherein the display control circuit determines the position information of the main area by performing block-based edge enhancement on the first input frame.

9. The display device according to claim 1, wherein the display control circuit determines position information of the main area by performing block-based moving average on the first input frame and taking an area corresponding to a maximum moving average value as the main area.

10. A display control circuit, comprising:
a luminance distribution determination circuit configured to determine luminance distribution for data of a surrounding area of a first input frame, wherein the first input frame comprises a main area and the surrounding area; and
an image adjustment circuit coupled to the luminance distribution determination circuit, and configured to adjust the data of the surrounding area of the first input frame according to the luminance distribution to generate a first output frame, such that a surrounding area of the first output frame has a less luminance than a main area of the first output frame has.

11. The display control circuit according to claim 10, further comprising:
a main area determination circuit configured to determine position information of the main area of the first input frame.

12. The display control circuit according to claim 10, wherein the image adjustment circuit adjusts the data of the surrounding area of the first input frame to generate the first output frame by applying a weight matrix to the first input frame.

13. The display control circuit according to claim 10, further comprising:
an image change detection circuit configured to detect a difference between the first input frame and a second input frame next to the first input frame, wherein
the luminance distribution determination circuit adjusts a weight matrix according to the difference, to generate an adjusted weight matrix, and
the image adjustment circuit adjusts data of a surrounding area of the second input frame to generate a second output frame to be displayed after the first output frame by applying the adjusted weight matrix to the second input frame.

14. The display control circuit according to claim 13, wherein a surrounding area of the second output frame has a less luminance than the surrounding area of the first output frame has in response to the difference between the first input frame and the second input frame being less than a threshold.

15. The display control circuit according to claim 13, wherein a surrounding area of the second output frame has same luminance as the surrounding area of the first output frame in response to the difference between the first input frame and the second input frame not being less than a threshold.

16. The display control circuit according to claim 11, wherein the main area determination circuit determines the position information of the main area by performing block-based edge enhancement on the first input frame.

17. The display control circuit according to claim 11, wherein the main area determination circuit determines the position information of the main area by performing block-based moving average on the first input frame and taking an area corresponding to a maximum moving average value as the main area.

18. An image processing method of a display control circuit, comprising:
determining, by a luminance distribution determination circuit of the display control circuit, luminance distribution for data of a surrounding area of a first input frame, wherein the first input frame comprises a main area and the surrounding area; and
adjusting, by an image adjustment circuit of the display control circuit, the data of the surrounding area of the first input frame according to the luminance distribution to generate a first output frame, such that a surrounding area of the first output frame has a less luminance than a main area of the first output frame has.

19. The image processing method according to claim 18, further comprising:
determining, by a main area determination circuit of the display control circuit, position information of the main area of the first input frame.

20. The image processing method according to claim 18, further comprising:
adjusting, by the image adjustment circuit, the data of the surrounding area of the first input frame to generate the first output frame by applying a weight matrix to the first input frame.

21. The image processing method according to claim 18, further comprising:
receiving position information of the main area of the first input frame from a host processing unit.

22. The image processing method according to claim 18, further comprising:
detecting, by an image change detection circuit of the display control circuit, a difference between the first input frame and a second input frame next to the first input frame;
adjusting, by the luminance distribution determination circuit, a weight matrix according to the difference, to generate an adjusted weight matrix; and
adjusting, by the image adjustment circuit, data of a surrounding area of the second input frame to generate a second output frame by applying the adjusted weight matrix to the second input frame.

23. The image processing method according to claim 22, wherein a surrounding area of the second output frame has a less luminance than the surrounding area of the first output frame has in response to the difference between the first input frame and the second input frame being less than a threshold.

24. The image processing method according to claim 22, wherein a surrounding area of the second output frame has same luminance as the surrounding area of the first output frame in response to the difference between the first input frame and the second input frame not being less than a threshold.

25. The image processing method according to claim 19, further comprising:
determining, by the main area determination circuit, the position information of the main area by performing block-based edge enhancement on the first input frame.

26. The image processing method according to claim 19, further comprising:
determining, by the main area determination circuit, the position information of the main area by performing block-based moving average on the first input frame and taking an area corresponding to a maximum moving average value as the main area.

27. A display device comprising:
an OLED display panel being driven to display a first output frame in a normal mode and display a second output frame in a power saving mode, wherein the OLED display panel has less power consumption in the power saving mode than in the normal mode, and a surrounding area, which is an area other than a main area, of the second output frame has a less luminance than the surrounding area of the first output frame has; and
a display control circuit coupled to the OLED display panel and configured to generate the first output frame and the second output frame, which results in a first luminance difference between the luminance of the main area of the second output frame and the luminance of the main area of the first output frame and a second luminance difference between the luminance of the surrounding area of the second output frame and the luminance of the surrounding area of the first output frame, wherein the second luminance difference is greater than the first luminance difference.

28. The display device according to claim 27, wherein the display control circuit adjusts data of the surrounding area of a first input frame to generate the first output frame, by applying a first weight matrix to the first input frame, and adjusts data of the surrounding area of a second input frame to generate the second output frame, by applying a second weight matrix to the second input frame.

29. The display device according to claim 27, further comprising:
a host processing unit coupled to the display control circuit, wherein the display control circuit is configured to receive position information of the main area of a first input frame from the host processing unit.

30. The display device according to claim 27, wherein the display control circuit is configured to determine position information of the main area of a first input frame.
